(19) United States
(12) Patent Application Publication
(10) Pub. No.: US 2019/0316860 A1
(43) Pub. Date: Oct. 17, 2019

(54) Method for Tracking and Monitoring Firearms

(71) Applicants: Erick Rowland Steffens, Mesa, AZ (US); Kyle Ruben Carpenter, Phoenix, AZ (US)

(72) Inventors: Erick Rowland Steffens, Mesa, AZ (US); Kyle Ruben Carpenter, Phoenix, AZ (US)

(21) Appl. No.: 16/382,134

(22) Filed: Apr. 11, 2019

Related U.S. Application Data
(60) Provisional application No. 62/656,221, filed on Apr. 11, 2018.

(51) Int. Cl. F41A 17/06; G01S 19/16

(52) U.S. Cl. CPC F41A 17/063; F41A 9/65; G01S 19/16

(57) ABSTRACT

The method for tracking and monitoring firearms provides a global positioning system (GPS)-enabled firearm ammunition magazine for all firearm types. A standard magazine is internally fitted with a GPS tracking unit, making the magazine look like any other firearm ammunition magazine. The GPS-enabled firearm ammunition magazine provides the information necessary for its recovery in the event of theft, misplacement, or other loss. GPS data is sent to at least one remote server, where it is recorded and processed. The remote server can send signals back to the magazine so that a mechanical securing mechanism integrated into the firearm magazine can actuate, preventing bullets from entering the firearm chamber. An application programming interface enables integration of the present invention with existing security cameras, thus allowing the remote servers to access and archive relevant video footage of an equipped firearm magazine.

The current application claims a priority to the U.S. Provisional Patent application Ser. No. 62/656,221 filed on Apr. 11, 2018.

### FIELD OF THE INVENTION

The present invention generally relates to firearm accessories. More specifically, the present invention is a method for tracking and monitoring firearms through the use of an integrated global positioning system (GPS).

### BACKGROUND OF THE INVENTION

Firearm magazines are the bullet containers and feeding devices integrated or attached to the body of a repeating firearm. Different types of firearm magazines comprising different designs and structures are adapted to fit the various types of firearms. Among the most popular and used firearm magazines are known as box magazines. Box magazines, as the name implies, are generally rectangular hollow devices with ammunition laterally arranged within. The ammunition within a box magazine can be stacked in various patterns, like a single column or staggered. A feeding mechanism is further provided in the body of the box magazine, so the ammunition feeds into the firearm.

While current designs and structures for firearm magazines are efficient and very useful, the usage of firearms is not currently regulated effectively. As a result of various violent incidents, firearms in general tend to receive a bad reputation. While debate over gun control policy is hotly contested, particularly in the United States, any resultant increase in gun regulation would require technology that allows for effective implementation of those policies. However, most firearm magazines still lack the ability to provide their location anytime users require to locate the magazines remotely. Remote tracking capabilities have been implemented in vehicles, airplanes, cellular devices, and other such inventions; however, such capabilities have not been implemented on firearm magazines. Remote tracking for firearm magazines would not only allow regulatory bodies to monitor and assess firearms in general but would also allow users to remotely track the position of a magazine and the corresponding firearm to which the magazine is attached, and consequently locate the position of the firearm. If the firearm or magazine became lost or stolen, remote tracking capabilities would allow users and authorities to track and locate the position of the magazine and/or firearm in order to retrieve them. Further, the ability of the user to remotely lock the firearm magazine could prevent firearm abuse. What is needed is a firearm magazine with integrated remote tracking capabilities. Further desirable is such a device that includes a mechanism for preventing unauthorized usage of the firearm, especially within certain areas. Further desirable is a device which integrates with existing cameras for tracking purposes.

The present invention addresses these issues. The method for tracking and monitoring firearms provides a global positioning system (GPS)-enabled firearm ammunition magazine for all firearm types. A standard magazine is internally fitted with a GPS tracking unit, making the magazine look like any other firearm ammunition magazine. The GPS-enabled firearm ammunition magazine provides the information necessary for its recovery in the event of theft, misplacement, or other loss. The present invention is also effective for firearm ammunition magazine owners who retrofit their existing magazines with GPS capabilities. The GPS data is sent to at least one remote server, where it is recorded and processed. The remote server can send signals back to the magazine so that a mechanical securing mechanism integrated into the firearm magazine can actuate, preventing bullets from entering the firearm chamber. An application programming interface enables integration of the present invention with existing security cameras, thus allowing the remote servers to access and archive relevant video footage of an equipped firearm magazine.

### BRIEF DESCRIPTION OF THE DRAWINGS

FIG. 1 is a flowchart illustrating the overall process for the method of the present invention.

FIG. 2 is a flowchart illustrating the subprocess of actuating an ammunition locking mechanism.

FIG. 3 is a flowchart illustrating the subprocess of determining firearm usage with an accelerometer.

FIG. 4 is a flowchart illustrating the subprocess of determining firearm usage with a microphone.

FIG. 5 is a flowchart illustrating the subprocess of adding a geospatial zone to the plurality of geospatial safe zones.

FIG. 6 is a flowchart illustrating the subprocess of archiving an ammunition quantity in the remote server.

FIG. 7 is flowchart illustrating the subprocess of archiving real-time global positioning system (GPS) data in the remote server.

FIG. 8 is flowchart illustrating the subprocess of archiving video footage from a plurality of video surveillance cameras.

### DETAILED DESCRIPTION OF THE INVENTION

All illustrations of the drawings are for the purpose of describing selected versions of the present invention and are not intended to limit the scope of the present invention.

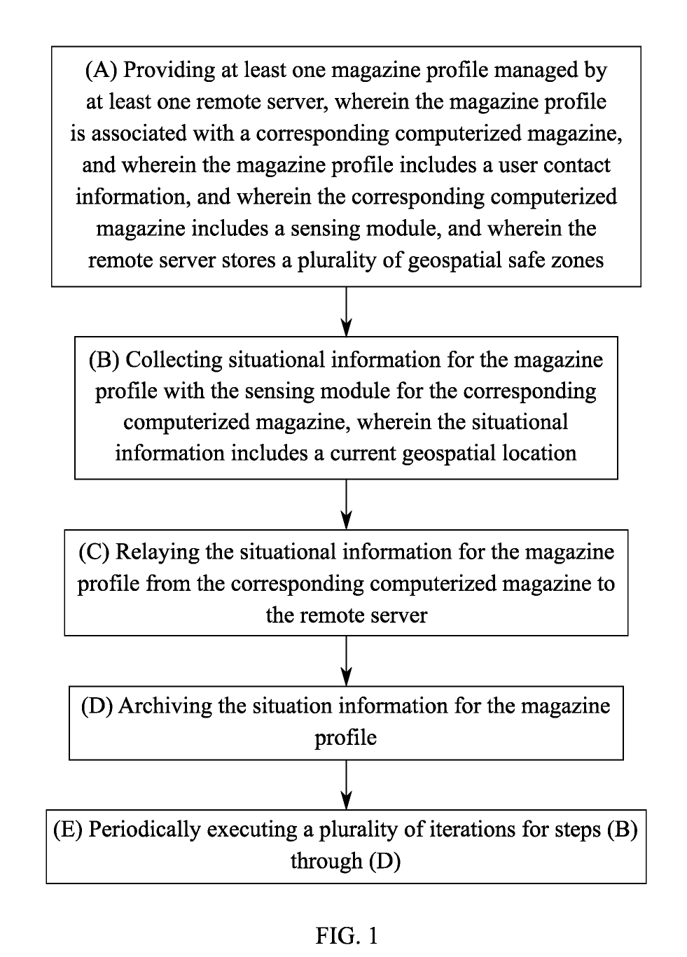

The present invention is a method for tracking and monitoring firearms that provides a user with location information for a firearm ammunition magazine. Referring to FIG. 1, the present invention accomplishes this by enabling global positioning system (GPS) data to emit from the firearm magazine for subsequent collection and distribution by several remote servers. The system of the present invention includes at least one magazine profile managed by at least one remote server (Step A). The magazine profile relates to the data associated with a gun or firearm, specifically data associated with the magazine of said gun or firearm. The at least one remote server is a computing device remotely accessible by the magazine profile that allows for capture, organization, and transmission of data from the magazine profile. The magazine profile is associated with a corresponding computerized magazine. The corresponding computerized magazine is a magazine that is equipped with system components, including but not limited to a portable power source, a processor, electrical connections, and more that allow for transmission of location data to the remote server. This arrangement enables communication from the magazine to the remote server, which enables subsequent storage and analysis of data relating to the physical aspects of the corresponding computerized magazine by the remote server. The magazine profile includes user contact information. The user contact information is assorted data about the owner of the firearm ammunition magazine, including owner name, gun registration information, address, phone number, email address, location information, and more. Such information allows authorities to identify the owner of the corresponding computerized magazine. The corresponding computerized magazine includes a sensing module. The sensing module is a set of detectors that transmit electrical signals in response to specific environmental stimuli, particularly the location, ammunition quantity, and firing status of the corresponding computerized magazine. The remote server stores a plurality of geospatial safe zones. The plurality of geospatial safe zones is a set of preferably coordinate-based boundaries that define an area to monitor. The plurality of geospatial safe zones may include city centers, event locations, personal residences, business buildings, parks, and more.

The present invention follows an overall process in order to locate and remotely manage corresponding computerized magazine. For the overall process, situational information for the magazine profile is collected with the sensing module for the corresponding computerized magazine (Step B). This situational information describes various conditions and status updates about the corresponding computerized magazine. In particular, data or information that may be collected as the situational information includes a current geospatial location. The current geospatial location is the GPS coordinates of the corresponding computerized magazine. Referring to FIG. 1, the situational information for the magazine profile is then relayed from the corresponding computerized magazine to the remote server (Step C). To this end, the remote server may utilize the current geospatial location for subsequent calculations. Situational information for the magazine profile is archived on the remote server (Step D). This allows data to be stored remotely as needed. Such data is valuable for various analyses and for access and usage by appropriate authorized parties. Situational information may be stored and arranged in many different forms, and the remote servers may be programmed to organize the situational information for subsequent use by any of several application programming interfaces (APIs), libraries, or frameworks in order to ultimately provide the most practical arrangement of data. Finally, a plurality of iterations for Step B through Step D is executed for continuous and real-time monitoring (Step E). Thus, the situational information is periodically sent to the remote server. The situational information could be sent continuously, or with a lower frequency, depending on user settings and technological capabilities.

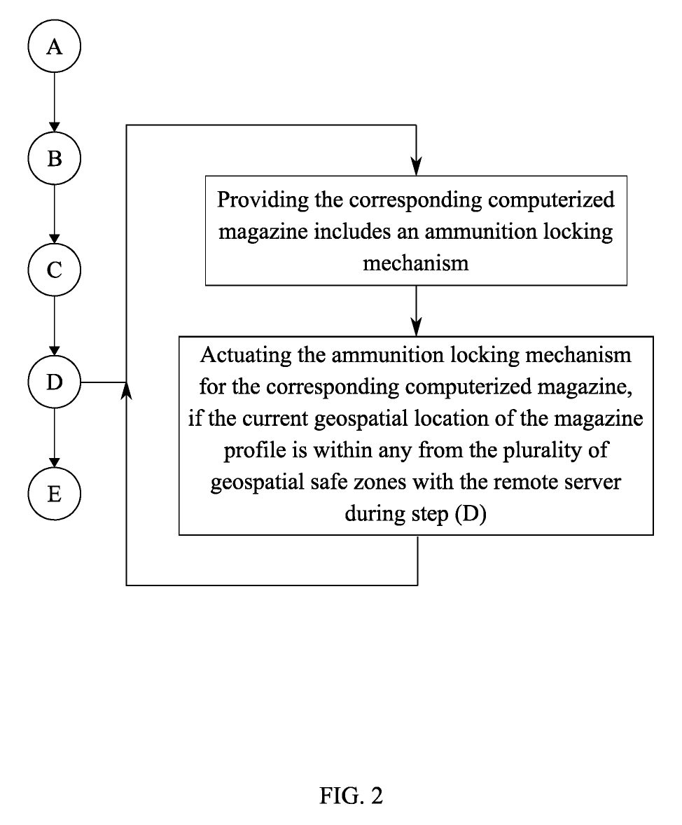

If the current geospatial location is found to be outside of a geospatial safe zone, the remote server continues to monitor the situational information; however, further action may be desirable to prevent a dangerous incident. To this end, the corresponding computerized magazine includes an ammunition locking mechanism. The ammunition locking mechanism is a set of mechanical components that physically lock the magazine, thus preventing the passage of contained bullets into a firearm bullet chamber. The ammunition locking mechanism may include a pin, a slot, and an actuator, where the slot is positioned at the end of the corresponding computerized magazine and the actuator slides the pin through the slot, thus blocking bullets from exiting the corresponding computerized magazine. The remote server analyzes the situational information by comparing the current geospatial location with the plurality of geospatial safe zones and subsequently determining the existence of any overlap. If the current geospatial location is found to be within a geospatial safe zone, the ammunition locking mechanism is actuated, as indicated in FIG. 2, preventing the bullets within the corresponding computerized magazine from entering the associated firearm. The ammunition locking mechanism can also be actuated to allow bullets to shift into the associated firearm upon exiting the geospatial safe zone. The remote server is equipped to analyze the current geospatial location relative to the plurality of geospatial safe zones and provide a corresponding actuating signal to the ammunition locking mechanism as necessary. Therefore, the remote server can compare the magazine profile location with the plurality of geospatial safe zones in order to determine whether to actuate the ammunition locking mechanism.

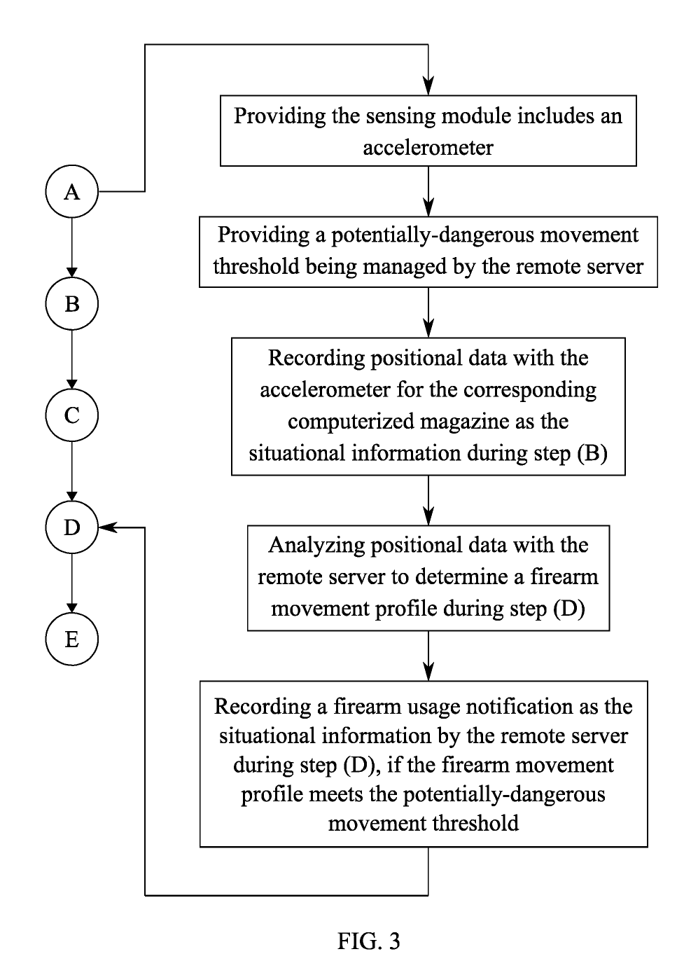

The overall process provides the remote server with situational information about the location of a corresponding computerized magazine, tracking the corresponding computerized magazine in real-time. The sensing module includes an accelerometer, as seen in FIG. 3. The accelerometer is a sensor which detects and tracks changes in the accelerometer's position over time. Further, the present invention includes a potentially-dangerous movement threshold that is managed by the remote server. The potentially-dangerous movement threshold is a specified value representing the upper limit of acceptable accelerometer movement. In this way, a sudden movement spike as recorded by the accelerometer can be determined to be the result of firing of the associated firearm. Positional data is recorded with the accelerometer for the corresponding computerized magazine as the situational information during Step B. This provides the remote server with the positional data. The positional data is analyzed with the remote server to determine a firearm movement profile during Step D. In this way, the remote server is equipped to determine whether the associated firearm is discharged. Finally, a firearm usage notification is recorded as the situational information by the remote server during Step D, if the firearm movement profile meets the potentially-dangerous movement threshold. Thus, the remote server can record firearm usage for subsequent analysis or general archiving.

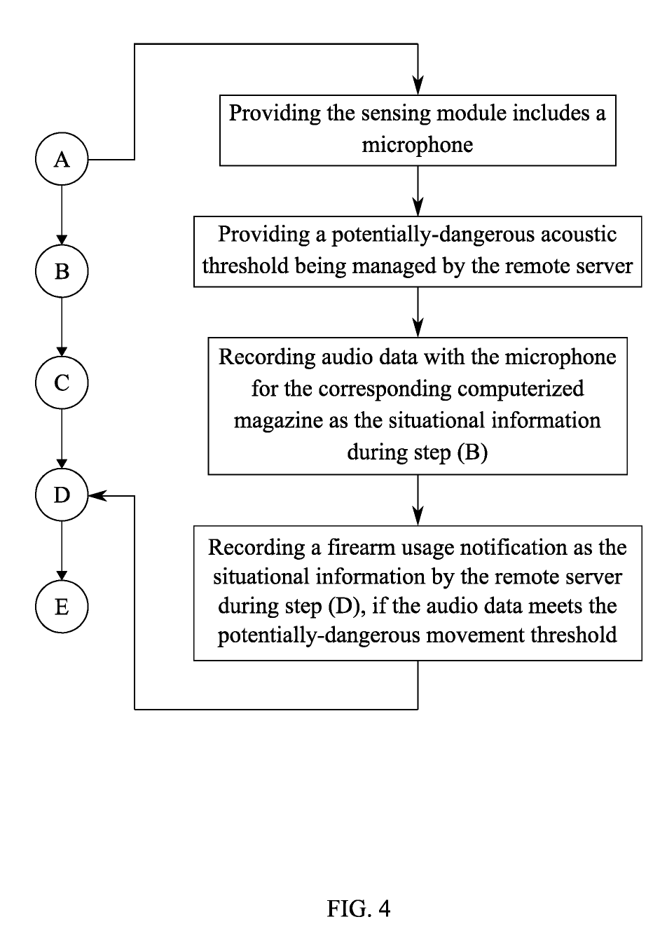

In order to determine whether the firearm has been fired, the present invention must be equipped to receive additional data to supplement the data obtained by the accelerometer. To this end, the sensing module also includes a microphone, as seen in FIG. 4. The microphone is an audio-capturing device that collects audio data directly about or around the firearm. Further, the present invention includes a potentially-dangerous acoustic threshold that is managed by the remote server. The potentially-dangerous acoustic threshold is a specified value measuring volume, pitch, or other preferably decibel-based metric representing the upper limit of acceptable ambient noise.

Audio data is recorded with the microphone for the corresponding computerized magazine as the situational information during Step B. Thus, the audio data is provided to the remote server for subsequent analysis. Finally, a firearm usage notification is recorded as the situational information by the remote server during Step D, if the audio data meets the potentially-dangerous acoustic threshold. The present invention is therefore equipped to determine firearm usage based upon the noise generated by shooting the firearm.

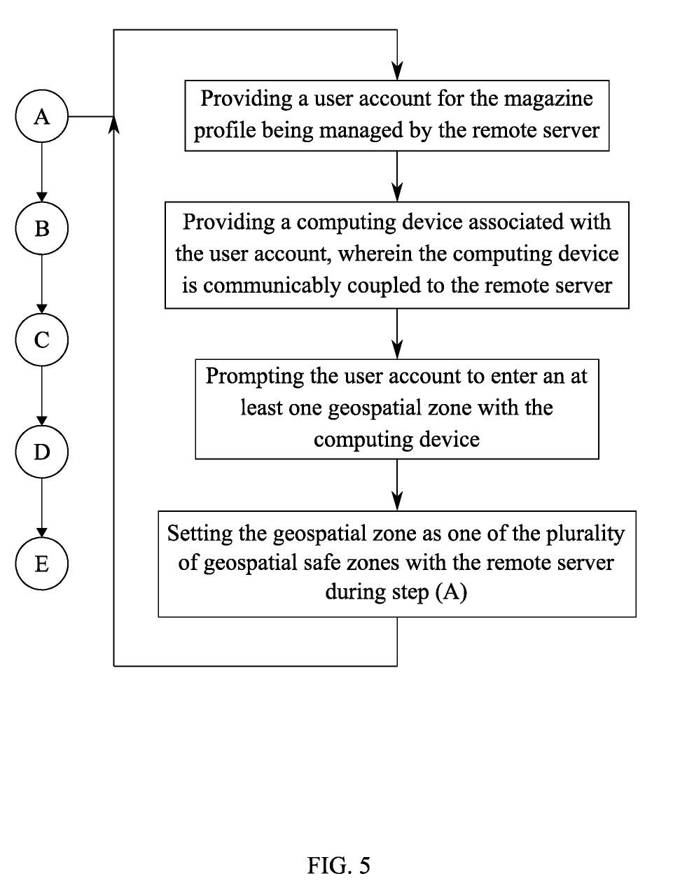

The present invention requires additional processes by which archived data can be accessed by authorized parties, and by which a user may add to, specify, and or manage the plurality of geospatial safe zones. To this end, the magazine profile includes a user account that is managed by the remote server. The user account relates to the owner of the corresponding computerized firearm. The user account may also relate to authorities overseeing the usage of the corresponding computerized firearm. A computing device is associated with the user account, as referenced in FIG. 5. Type of devices that may be used as the computing device includes, but is not limited to, portable computing devices, personal computing devices, or other devices capable of connecting to the remote server.

The computing device is communicably connected to the remote server. This connection allows the computing device to send signals to the remote server, and for the remote server to respond with relevant requested information. Subsequently, the user account is prompted to enter an at least one geospatial zone with the computing device. The user account is therefore capable of communicating coordinates or other location data to the remote server. In an exemplary embodiment, the at least one geospatial zone may be selected through interaction with a map, for user convenience. The geospatial zone is then appended to the plurality of geospatial safe zones with the remote server during Step A. This allows the user to designate different geospatial safe zones for usage by the remote server.

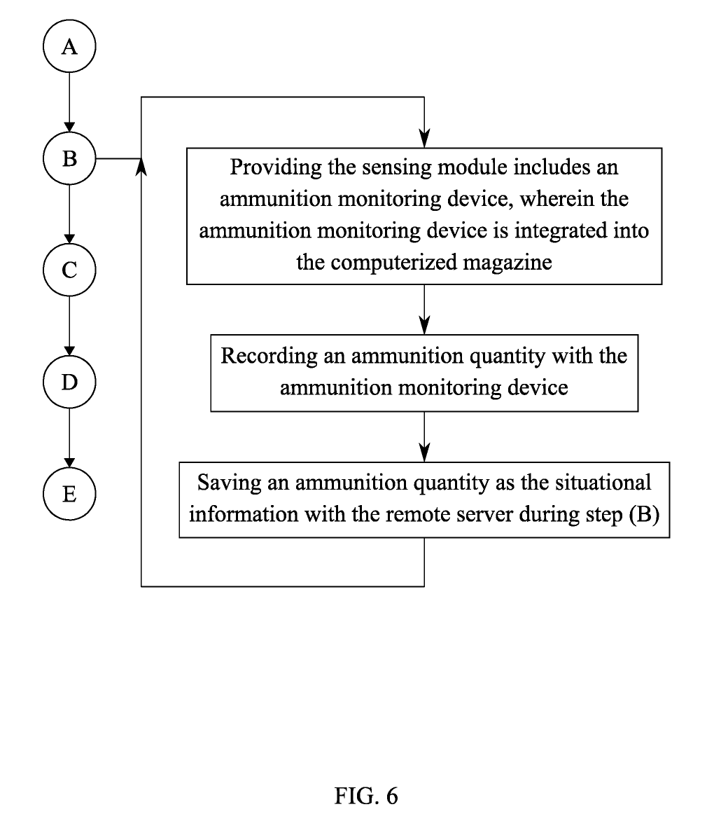

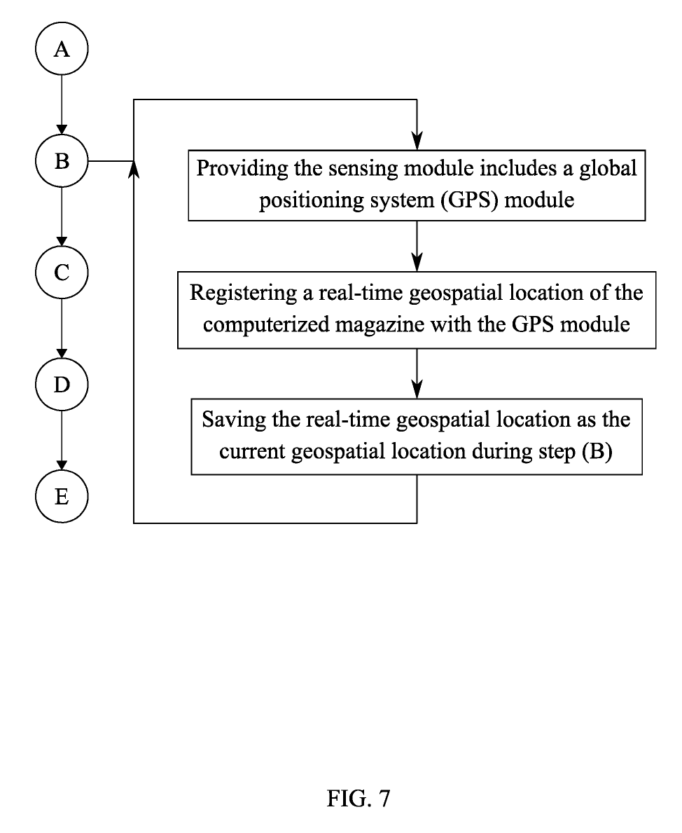

Additionally, the present invention provides further utility by tracking bullet usage. Referring to FIG. 6, the sensing module includes an ammunition monitoring device. The ammunition monitoring device is any array of sensors or motion-detecting tools oriented to monitor the position of contained bullets or shells. The ammunition monitoring device is integrated into the computerized magazine. Thus, the ammunition monitoring device is positioned to determine the number of bullets or shells remaining within the corresponding computerized magazine. The ammunition quantity is recorded with the ammunition monitoring device. Finally, the ammunition quantity is saved as the situational information with the remote server during Step B. Accordingly, the ammunition quantity is made available for archiving and analysis by the remote server. The present invention optimally functions when the sensing module provides the remote server with the most up-to-date data available. In order to allow for such data transfer, the sensing module includes a GPS module. The GPS module tracks and records the global position, preferably as coordinates or other useful data. The real-time geospatial location of the computerized magazine is registered with the GPS module, as displayed in FIG. 7. In this way, the GPS module collects the most recent data. Finally, the real-time geospatial location is saved as the current geospatial location during Step B. This arrangement allows the real-time geospatial location to be made available for archiving and analysis by the remote server.

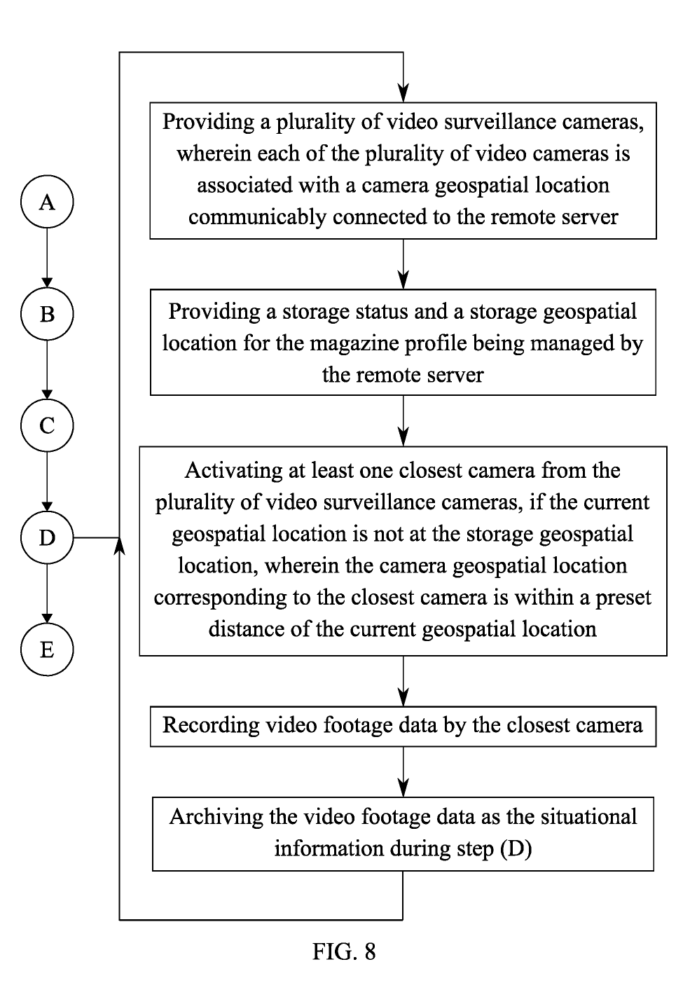

In many situations when a firearm has been stolen or moved unexpectedly, the user benefits from additional information regarding the location of the firearm. The present invention provides a means for tracking the firearm by tracking the magazine of the firearm. To this end, the present invention includes a plurality of video surveillance cameras. The plurality of video surveillance cameras is a set of video cameras strategically placed by various parties, including the user, municipalities, security systems, and others to monitor locations of interest. Each of the plurality of video surveillance cameras is associated with a camera geospatial location. Additionally, each of the plurality of video surveillance cameras is communicably connected to the remote server. This arrangement allows the remote server to determine the position of the plurality of video surveillance cameras. The present invention further includes a storage status and a storage geospatial location for the magazine profile being managed by the remote server. The storage status is an indicator that registers whether the firearm is being stored or being used. The storage geospatial location is the area in which the stored firearm resides for safe-keeping. If the current geospatial location is not at the storage geospatial location, the at least one closest camera from the plurality of video surveillance cameras is activated, wherein the camera geospatial location corresponding to the closest camera is within a preset distance of the current geospatial location, as seen in FIG. 8. In this way, the remote server collects video data from the video camera or cameras from the plurality of video surveillance cameras closest to the current geospatial location if the associated firearm has been removed from the storage geospatial location. The video footage data is recorded by the closest camera. In this way, the remote server collects only the most relevant video footage. Finally, the video footage data is archived as the situational information during Step D. In this way, the video footage data is made available for analysis and review by the user or the authorities.

While the present invention generally relates to a single user, the present invention could similarly be applied to several users. With multiple users contributing to the plurality of geospatial locations, more homes could be protected from firearms-related incidents. In such a situation, the remote servers would be in communication with each other. This allows each remote server shared access to data regarding current geospatial location, fired status, user contact information, and more. This scenario is advantageous in that more detailed and useful information is provided to the user, and more thorough analysis of firearm presence and general firearm safety is made possible.

Although the invention has been explained in relation to its preferred embodiment, it is to be understood that many other possible modifications and variations can be made without departing from the spirit and scope of the invention as hereinafter claimed.

What is claimed is:

1. A method for tracking and monitoring firearms, the method comprises the steps of:
(A) providing at least one magazine profile managed by at least one remote server, wherein the magazine profile is associated with a corresponding computerized magazine, and wherein the magazine profile includes a user contact information, and wherein the corresponding computerized magazine includes a sensing module, and wherein the remote server stores a plurality of geo spatial safe zones;
(B) collecting situational information for the magazine profile with the sensing module for the corresponding computerized magazine,
wherein the situational information includes a current geospatial location;
(C) relaying the situational information for the magazine profile from the corresponding computerized magazine to the remote server;
(D) archiving the situational information for the magazine profile on the remote server;
(E) periodically executing a plurality of iterations for steps (B) through (D).

2. The method for tracking and monitoring firearms, the method as claimed in claim 1 comprises the steps of:
providing the corresponding computerized magazine includes an ammunition locking mechanism;
actuating the ammunition locking mechanism for the corresponding computerized magazine, if the current geospatial location of the magazine profile is within any from the plurality of geospatial safe zones with the remote server during step (D);

3. The method for tracking and monitoring firearms, the method as claimed in claim 1 comprises the steps of:
providing the sensing module includes an accelerometer;
providing a potentially-dangerous movement threshold being managed by the remote server;
recording positional data with the accelerometer for the corresponding computerized magazine as the situational information during step (B);
analyzing positional data with the remote server to determine a firearm movement profile during step (D); and
recording a firearm usage notification as the situational information by the remote server during step (D), if the firearm movement profile meets the potentially-dangerous movement threshold.

4. The method for tracking and monitoring firearms, the method as claimed in claim 1 comprises the steps of:
providing the sensing module includes a microphone;
providing a potentially-dangerous acoustic threshold being managed by the remote server;
recording audio data with the microphone for the corresponding computerized magazine as the situational information during step (B); and
recording a firearm usage notification as the situational information by the remote server during step (D), if the audio data meets the potentially-dangerous acoustic threshold.

5. The method for tracking and monitoring firearms, the method as claimed in claim 1 comprises the steps of:
providing a user account for the magazine profile being managed by the remote server;
providing a computing device associated with the user account, wherein the computing device is communicably connected to the remote server;
prompting the user account to enter an at least one geospatial zone with the computing device; and
setting the geospatial zone as one of the plurality of geospatial safe zones with the remote server during step (A).

6. The method for tracking and monitoring firearms, the method as claimed in claim 1 comprises the steps of:
providing the sensing module includes an ammunition monitoring device, wherein the ammunition monitoring device is integrated into the computerized magazine;
recording an ammunition quantity with the ammunition monitoring device; and
saving an ammunition quantity as the situational information with the remote server during step (B).

7. The method for tracking and monitoring firearms, the method as claimed in claim 1 comprises the steps of:
providing the sensing module includes a global positioning system (GPS) module;
registering a real-time geospatial location of the computerized magazine with the GPS module; and
saving the real-time geospatial location as the current geospatial location during step (B).

8. The method for tracking and monitoring firearms, the method as claimed in claim 1 comprises the step of:
providing a plurality of video surveillance cameras, wherein each of the plurality of video surveillance cameras is associated with a camera geospatial location communicably connected to the remote server;
providing a storage status and a storage geospatial location for the magazine profile being managed by the remote server;
activating at least one closest camera from the plurality of video surveillance cameras, if the current geospatial location is not at the storage geospatial location, wherein the camera geospatial location corresponding to the closest camera is within a preset distance of the current geospatial location;
recording video footage data by the closest camera; and
archiving the video footage data as the situational information during step (D).
